(19) United States
(12) Patent Application Publication
(10) Pub. No.: US 2003/0095045 A1
(43) Pub. Date: May 22, 2003

(54) Predator warning device for birds and the like

(76) Inventor: Gordon Secker, Sharon Springs, NY (US)

Correspondence Address: Thomas A. O'Rourke, Wyatt, Gerber & O'Rourke, 99 Park Avenue, New York, NY, 10016, US

(21) Appl. No.: 09/997,474

(22) Filed: Nov. 19, 2001

(51) Int. Cl. G08B 23/00

(52) U.S. Cl. 340/573.2; 340/384.2

(57) ABSTRACT

A warning device to alert birds and the like of the presence of a predator is disclosed. The apparatus emits a first audible warning signal having a first frequency audible to one type of prey and a second audible warning signal having a second frequency audible to a second type of prey. One warning signal may be at a frequency in the range of about 20 to 40 kilohertz and the second warning signal may be at a frequency in the range of about 1 to 20 kilohertz.

### FIELD OF THE INVENTION

The present invention is directed to improvements in warning systems for birds and other small desirable animals. The device is designed to be worn by pets particularly felines and provide an audible signal to alert the birds that a predator is in the vicinity.

### BACKGROUND OF THE INVENTION

The most popular pet in this country is the cat. Cats have been domesticated for many thousands of years. One of the advantages that man achieved in the domestication of cats by man in the dawn of time arose from the cat's excellent ability to hunt and eradicate vermin that can infest food supplies or cause disease. In many ancient civilizations where the threat of famine was ever present, a cat protecting the grain from mice, birds and other creatures could be very advantageous. This was a very important attribute of felines and made them highly honored in ancient civilizations. For example, in many Egyptian works of art, gods or other prominent figures are frequently depicted as cats or with catlike features.

As time has gone on, the traditional role of cats has been diminished as the farming population has decreased and they are primarily sought for their companionship instead of their ability to hunt. Although we no longer necessarily select our cats for their hunting ability this trait is still very strongly present in our cat population today. While many cats reside indoors and seldom go outside, there are large numbers of cats that are permitted by their owners to roam outside for even short periods of time. As many cat owners will agree their pets frequently enjoy hunting and stalking other small animals in the neighborhood. Cats because of their natural tendencies as hunters are particularly attracted to birds and small animals such as rabbits, mice, and squirrels, which they frequently delight in stalking and attacking. It is not uncommon for a cat owner to be greeted some mornings with an offering from their pet of a portion of the nights catch on a porch or stoop. While some cat owners make attempts to curb this natural behavior it is very difficult to do and not always successful.

While most people do not have problems when the cats hunt mice, rats and other pests, many cat owners are disturbed when the prey is a songbird or other popular bird. As a result, there have been a number of products over the years that attempt to solve the problem of cats attacking desired birds, particularly birds that may be endangered or rare. These approaches include such approaches as that shown in U.S. Pat. No. 5,983,838 where there is a sheet hanging from the cats neck that renders it difficult for the cat to maneuver in hunting birds. In addition, the inventor of the present invention developed a warning system that can be worn by cats that sends out an audible warning signal. The device is shown in U.S. Pat. No. 5,952,925 the disclosures of which are incorporated herein by reference. This device had an electronic device that contained a power source and electronic circuit. The electronic circuit had four different pairs of dip switches, a speaker and a volume control in communication with the speaker. A frequency generator was in electronic communication with the volume control through an electronic switch and the first pair of dip switches.

One of the difficulties that some of the prior art devices has related to their size. Many of these devices were very large and became a burden for the cat to wear around their neck. As a result, many cats would have a tendency to claw at the apparatus in an attempt to remove the apparatus. Another problem with these devices was that since they were battery operated, battery life was a significant issue to keep these products operating. Where the battery life was short it frequently became a burden for the pet owner to change the battery frequently and as a result, there was a tendency for the pet owner to cease the use of the device where battery replacement was an expense or a time burden due to frequent replacement. Another issue with respect to prior devices related to the type of signal that was generated. Different birds have different abilities to hear different frequencies. If one frequency was selected for the device birds that did not hear that frequency were not warned of the presence of the cat.

As a result, there has been a need for an improved bird warning device that is lightweight when worn by a cat, that has a long battery life and which has a broad spectrum of frequencies that provides warning to a wide variety of birds.

### OBJECTS OF THE INVENTION

It is an object of the invention to provide an apparatus that may be worn by a pet that will emit an audible signal at a frequency that will alert birds of the presence of a domesticated predator and permit the bird to escape unharmed.

It is an object of the invention to provide an apparatus that will alert a broad spectrum of bird types of the presence of a predator.

It is also an object of the invention to provide a warning apparatus for birds and the like that is compact in size and which will not hinder the pet's movements.

It is also an object of the present invention to provide protection to a cat's neck area, in the event a cat is attacked by a dog or other animal.

It is another object of the invention to provide a device that emits a warning signal to birds and other desired animals that can be worn by a cat or the like that is compact and will not create a safety hazard for the cat when worn outside.

It is a still further object of the invention to provide a warning device for cats and other pets that has a long battery life due to the reduced power needs of the design.

It is another object of the invention to provide an apparatus that may be conveniently worn by a pet that emits regular warning signals at a rate sufficient to alert a bird or other animal of the presence of a predator without causing the battery to become discharged too quickly.

### SUMMARY OF THE INVENTION

The present invention is directed to an improved warning device to alert birds and the like of a predator in the vicinity. The predator is usually a cat but can be any other pet that may be provided with the device. The device has an apparatus for emitting a first audible warning signal having a first frequency audible to one type of prey and a second audible warning signal having a second frequency audible to a second type of prey. In the case of using the warning device to protect birds the first signal is preferably at a frequency that is audible to one group of birds, for example, song birds. The second signal is preferably at a frequency audible to a second type of birds such as large birds that typically hear different frequencies than song birds. The signals will alert the birds of the presence of a predator, such as a cat.

### BRIEF DESCRIPTION OF THE DRAWINGS

FIG. 1 is a side view of a partially separated representative case or housing for the mechanism of the present invention.

FIG. 2 is a cut away view of the case of FIG. 1

FIG. 3 is an example of a flow chart describing a preferred embodiment of the operation of the present invention.

FIG. 4 is a schematic of the timing of the cycles of the warning device of the present invention.

FIG. 5 is a circuit diagram of the apparatus of the present invention.

FIG. 6 is a schematic of the layout of the components in the case of FIG. 1.

FIG. 7 is a schematic of the components overlaid on the schematic of FIG. 6.

### DETAILED DESCRIPTION OF THE INVENTION

The present invention is directed to an improved warning device to be worn by cats and other pets that have a tendency to hunt for birds and other desirable fauna. These pets can include, besides cats, ferrets, foxes and mongooses. The warning device of the present invention preferably comprises a small lightweight case 10. The case may preferably be in two segments 11 and 12 if desired. The two segments may be joined by, for example, a threaded coupling, by a bayonet type coupling or other suitable means. The case may be secured to the pet by a collar 13. It will be appreciated by those skilled in the art that although the two segments of the case have been shown having relatively equal length along their axis, the segments need not have that arrangement and one of the segments may be considerably shorter than the other.

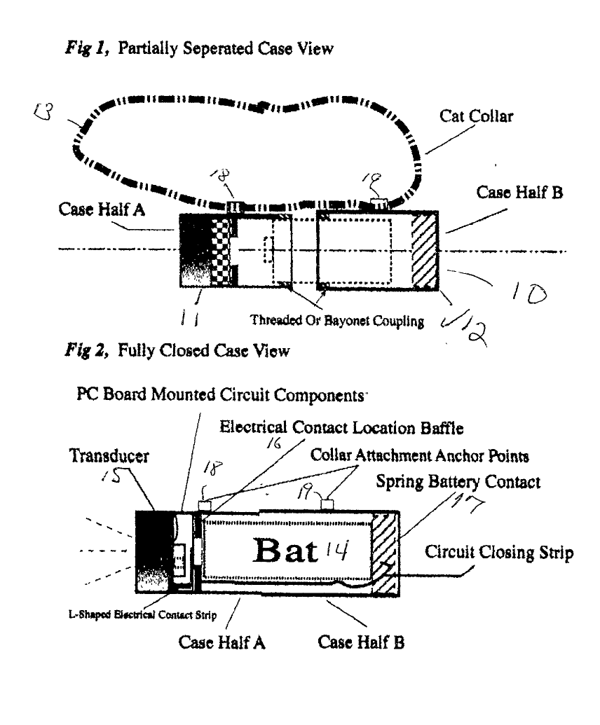

The case 10 will hold the battery 14, which powers a transducer 15 that emits an audible signal. There may be an electrical contact baffle 16 on one side of the battery 14 and a spring battery contact 17 on the opposite side. On the outer surface of the case there may be a means for securing the collar to the 13 case. As seen in FIGS. 1 and 2 there may be a pair of collar attachment anchor points 18 and 19 to secure the collar to the case.

This power supply is preferably a battery which may be the traditional single use type battery or if desired it may be rechargeable. The selection of the type of power supply is not critical. However, it has been found that batteries of the type sold by KJK International under the name Tekcell™ (a lithium based battery) provide suitable life. The receptacle 10 preferably is provided segments that are removable to provide access to the battery for replacing a discharged battery. The coupling of the segments 11 should provide a moisture proof seal as the device will be worn outside by the pet in all different types of weather. Water entering the receptacle where the mechanism is located can cause the device to become disabled. The size and shape of the warning device of the present invention is not critical and can vary depending on such aspects as aesthetics, size of the pet etc. One preferred shape is shown in FIG. 1 which depicts the device of the present invention as a circular tube sealed at each end. This shape has been found to be useful because of the shape of the typical power supply and the arrangement of the warning device of the present invention permits the device to be compactly positioned in a circular tube.

The mechanism of the warning device of the present invention differs from the prior art devices in that the features of the warning signal and the cycles thereof can be selected as desired. Dip switches while useful in controlling a warning device had serious difficulties. First, the dip switches could not be adjusted to specific periods on and off time. Consequently, the device was always on and this had a tendency to drain the battery too quickly. The only way to compensate for the power drain was to increase the size of the battery. While this would provide a longer battery life it made the device too large to be conveniently worn by a cat. If the battery were smaller the battery would drain quickly and need to be replaced sooner than it was desirable or convenient for the owner of the pet.

The operation of the warning system of the present invention is software controlled. At start up, the device preferably emits an initiating signal that alerts the pet owner that the device is turned on and operating. This signal can be a light or a tone. If a tone, this tone is an audible signal to the pet owner and the signal can be set to go off at any desired interval and for any length of time desired. It has been found that if the tone signaling the device is on and operating goes off every four cycles the pet owner is provided with sufficient information and the power supply is not adversely affected by this rate of signaling. Preferably, the tone is selected so that the sound level is balanced. If the tone is too great, the sound can irritate or even damage the cat's hearing. Also too great a sound can cause the battery to use more power and wear out more quickly. If the tone is too low, the sound may not provide sufficient warning to the prey.

In the preferred embodiment, the signal to the pet owner can be an audible tone in the range of human hearing. One example is a signal of about 1.5 kilohertz. The signal can last for any period desired. A signal of about 1.5 seconds has been found to be long enough for the pet owner to hear. One of the tradeoffs that have to be made is the amount of time a signal is emitted and the number of time the signal is issued by the device. The more frequently the signal is emitted the greater the drain on the battery. Similarly, the longer the signal is given the shorter the battery life as well. The preferred embodiment of the present invention as set forth herein provides sufficient warning to birds and other animals and permits the device to be used for about six or more months without replacing the battery. The advantage of a six month battery life are reduced cost, a greater likelihood the consumer will replace the battery when worn out as it will not be too frequent an occurrence. One advantage of a six month battery life is that a pet owner can plan to change the battery at the time of the year when day light savings time begins or ends in the same manner as the batteries for smoke detectors are recommended to be changed as well.

The device of the present invention emits a signal at different frequencies. In one embodiment, the signals are emitted at two separate frequencies. One frequency is a frequency that is audible by most songbirds. The songbirds include warblers, swallows, orioles, meadowlarks, nightingale's etc. This preferred frequency is in the range of about 20 to about 100 kilohertz's and more preferably about 40 kilohertz. The second frequency is at a frequency that is heard by larger birds. Typically these larger birds include robins, cardinals and crows. The preferred frequency for the larger birds are in the range of about 250 to about 21,000 cycles per second and more preferably about 20 kilohertz. Each warning signal whether it is at the higher frequency or the lower frequency lasts for about one second. A signal of about one second has been found to provide a satisfactory warning signal to the prey.

In a preferred embodiment, the apparatus of the present invention emits a first signal at a frequency audible by one type of bird followed by a second signal at a frequency audible by a second type of bird. For example, the first signal can be emitted at a frequency audible by small birds say 40 kilohertz followed by a second signal of 20 kilohertz audible by a larger bird. It will be appreciated that the large bird signal can proceed the small bird signal if desired. After the second signal there is preferably a delay of about ⅓ to about 1-second and more preferably a delay of about of one-half second. It is desirable to follow the delay with a second cycle similar to the first cycle or a variation thereon as desired. For example, the second cycle can be the opposite of the first cycle or the same. Alternatively, the second cycle can have the same small bird signal followed by the large bird signal but at a different frequency range than the first cycle.

In one embodiment, there are a total of four warning cycles in succession followed by an idle period. For example, there is a first song bird signal, a first large bird signal, a repeated, second large bird signal, a second song bird signal. Between each of the respective signals there is a delay of about one-half second. The order of the signals can vary as desired as can the number of cycles.

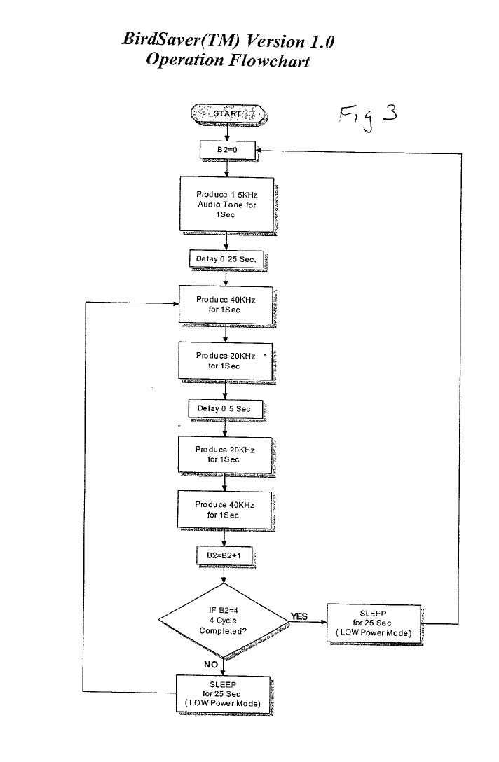

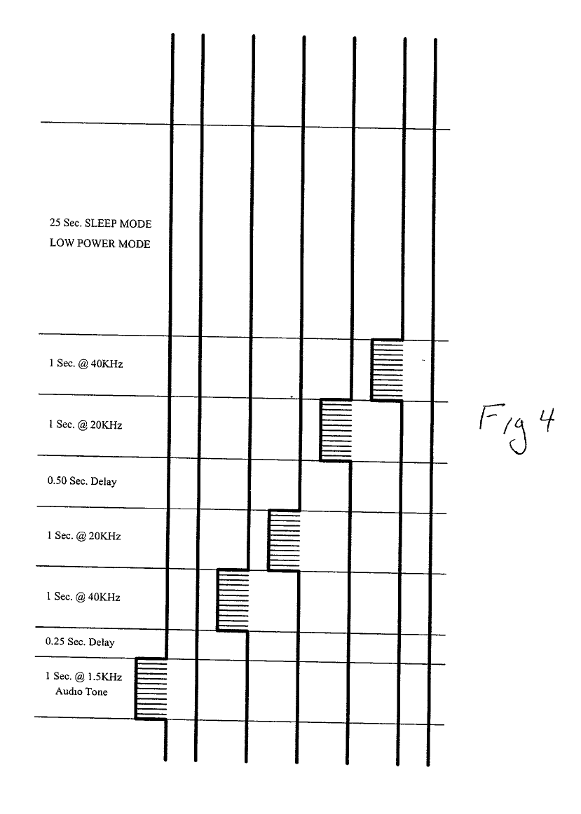

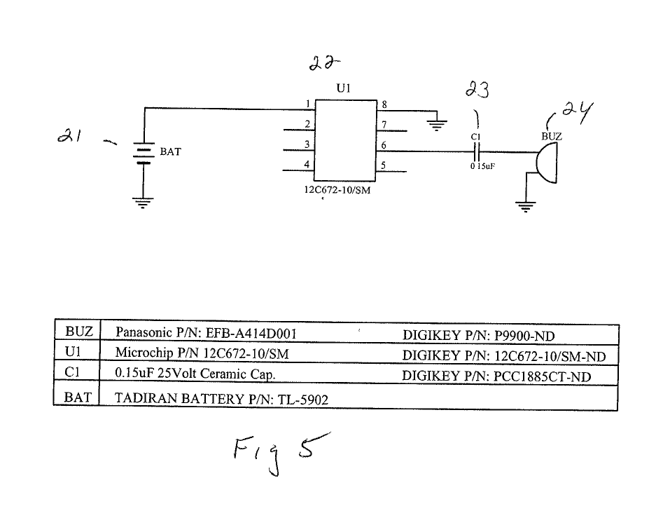

In order to preserve the life of the power supply, the last of the preselected number of cycles is followed by an idle mode. In the above example, after the completion of the pattern of four cycles there is an idle period. The length of the idle mode can vary depending on such factors as the age and agility of the cat, the quantity of birds in the area and other factors. Preferably, the idle mode can range from about 5 to 25 seconds. A preferred idle time is about 25 seconds. The length of the idle time in the cycle can vary as desired. The greater the idle time the longer the battery life. However, the longer the idle time the greater the risk that a predator wearing the device could attack its prey during the silent period. As a result, it has been found that an idle time of about 25 seconds is satisfactory for both bird safety and for prolonging the battery life. An example of this process is shown in more detail in FIG. 3. An example of the timing of the signals is shown in more detail in FIG. 4.

One software program that may be used in the present invention is the following:

DEFINE OSC 10 '10MHz Clock
B0 VAR BYTE
B1 VAR BYTE
B2 VAR BYTE
MAIN:
B2 = 0
FOR B0 = 1 TO 200
HIGH 1
PAUSEUS 350
LOW 1
PAUSEUS 350
NEXT B0
PAUSE 250
MAIN1:
′ ---- 40KHz ------------------------
FOR B0 = 1 TO 150
FOR B1 = 1 TO 250
HIGH 1
@ NOP
@ NOP
@ NOP
@ NOP
@ NOP
@ NOP
@ NOP
@ NOP
LOW 1
NEXT B1
NEXT B0
′ ---- 20KHz ------------------------
FOR B0 = 1 TO 50
FOR B1 = 1 TO 250
HIGH 1
@ NOP
@ NOP
@ NOP
@ NOP
@ NOP
@ NOP
@ NOP
@ NOP
@ NOP
@ NOP
@ NOP
@ NOP
@ NOP
@ NOP
@ NOP
@ NOP
@ NOP
@ NOP
@ NOP
@ NOP
@ NOP
LOW 1
@ NOP
@ NOP
@ NOP
@ NOP
@ NOP
@ NOP
@ NOP
@ NOP
@ NOP
@ NOP
@ NOP
NEXT B1
NEXT B0
′ -----------------------------------
PAUSE 500
′ ---- 20KHz ------------------------
FOR B0 = 1 TO 50
FOR B1 = 1 TO 250
HIGH 1
@ NOP
@ NOP
@ NOP
@ NOP
@ NOP
@ NOP
@ NOP
@ NOP
@ NOP
@ NOP
@ NOP
@ NOP
@ NOP
@ NOP
@ NOP
@ NOP
@ NOP
@ NOP
@ NOP
@ NOP
@ NOP
LOW 1
@ NOP
@ NOP
@ NOP
@ NOP
@ NOP
@ NOP
@ NOP
@ NOP
@ NOP
@ NOP
@ NOP
NEXT B1
NEXT B0
′ ---- 40KHz -----------------------
FOR B0 = 1 TO 150
FOR B1 = 1 TO 250
HIGH 1
@ NOP
@ NOP
@ NOP
@ NOP
@ NOP
@ NOP
@ NOP
@ NOP
LOW 1
NEXT B1
NEXT B0
′ -----------------------------------
B2 = B2 + 1
IF B2 = 4 THEN
SLEEP 25
GOTO MAIN
ELSE
SLEEP 25
GOTO MAIN1
ENDIF
END

The foregoing is merely an example of a software program that may be used to operate the device of the present invention. It will be appreciated by those skilled in the art that there are other variations that could be used and still accomplish the same result.

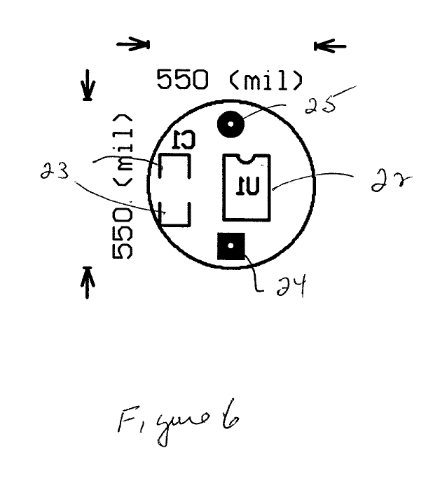

FIG. 5 shows a circuit drawing showing the battery 21, a microchip 22 that contains the software as well as a capacitor 23 connecting the transducer 24 (buzzer). The transducer is preferably a Panasonic EFB-A414D001. The microprocessor is preferably a Microchip P/N 12C672-10/SM. The capacitor is preferably a 0.15 uF 25 Volt ceramic capacitor. The battery is preferably a Tadiran battery, Part No.TL-5902. The advantage of using these parts is that a compact device is obtained that does not create problems for the animal due to its size. In addition, the battery is particularly useful since it combines long battery life in a compact relatively inexpensive battery.

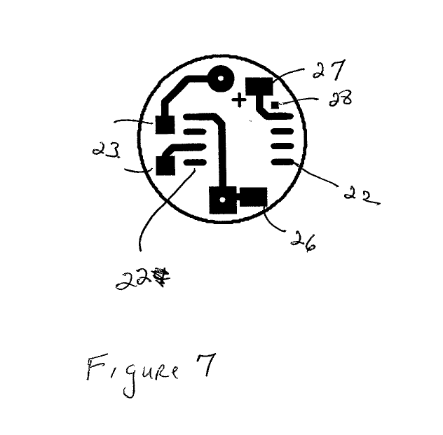

FIG. 6 shows an example of a silk screening showing an outline of the placement of the components in a generally circular opening having a diameter of about 550 mil. The dimensions and the shape can vary as desired. The capacitor 23 and the microchip 22 are shown as are the connecting points 24 and 25 for the transducer. FIG. 7 shows the layout of the components on the silk screening. There is the capacitor C1 23, the microprocessor U1 22, the negative connection of the battery 26 and the positive connection 27, a pin 28 for the microprocessor U1 22. As noted above, the cross section of the case is depicted as being circular giving the case a cylindrical shape. While any shape may be used the cylindrical shape is advantageous as it conforms to the general shape of the battery without wasted space. Also, the cylindrical form of the present invention offers a protective, material barrier to a cat's neck area in the event of a dog or other animal attack.

We claim:

1. A warning device to alert birds and the like of the proximity of a predator comprising an apparatus for emitting a first audible warning signal having a first frequency audible to one type of prey and a second audible warning signal having a second frequency audible to a second type of prey.

2. The warning device according to claim 1 wherein said one type of prey is a songbird and said second type of prey is a larger bird.

3. The warning device according to claim 2 wherein one warning signal is at a frequency in the range of about 20 to 40 kilohertz and the second warning signal is at a frequency in the range of about 1 to 20 kilohertz.

4. The warning device according to claim 3 wherein the first warning signal has a frequency at about 40 kilohertz and the second warning signal has a frequency at about 20 kilohertz.

5. The warning device according to claim 3 wherein the first warning signal has a frequency at about 40 kilohertz and the second warning signal has a frequency at about 20 kilohertz.

6. The warning device according to claim 4 wherein each warning signal lasts about 1 second.

7. The warning device according to claim 5 wherein each warning signal lasts about 1 second.

8. The warning device according to claim 6 wherein there is a delay of about one half second between each warning signal.

9. The warning device according to claim 7 wherein there is a delay of about one half second between each warning signal.

10. The warning device according to claim 1 wherein there is a set comprising a plurality of cycles of a first audible warning signal having a first frequency audible to one type of prey and a second audible warning signal having a second frequency audible to a second type of prey and wherein upon completion of a set there is an idle period before a second set begins.

11. The warning device according to claim 10 wherein the number of cycles in a set is four.

12. The warning device according to claim 10 wherein there is a signal recognizable by a user informing the user that the device is operating.

13. The warning device according to claim 12 wherein the signal is a tone audible to the user.

14. A method for alerting birds and the like of a predator comprising an emitted first audible warning signal having a first frequency audible to one type of prey and emitting a second audible warning signal having a second frequency audible to a second type of prey.

15. The method according to claim 14 wherein said one type of prey is a songbird and said second type of prey is a larger bird.

16. The method according to claim 15 wherein one warning signal is at a frequency in the range of about 20 to 40 kilohertz and the second warning signal is at a frequency in the range of about 1 to 20 kilohertz.

17. The method according to claim 16 wherein the first warning signal has a frequency at about 40 kilohertz and the second warning signal has a frequency at about 20 kilohertz.

18. The method according to claim 16 wherein the first warning signal has a frequency at about 40 kilohertz and the second warning signal has a frequency at about 20 kilohertz.

19. The method according to claim 17 wherein each warning signal lasts about 1 second.

20. The method according to claim 18 wherein each warning signal lasts about 1 second.

21. The method according to claim 19 wherein there is a delay of about one half second between each warning signal.

22. The warning device according to claim 20 wherein there is a delay of about one half second between each warning signal.

23. The method according to claim 14 wherein there is a set comprising a plurality of cycles of a first audible warning signal having a first frequency audible to one type of prey and a second audible warning signal having a second frequency audible to a second type of prey and wherein upon completion of a set there is an idle period before a second set begins.

24. The method according to claim 23 wherein the number of cycles in a set is four.

25. The method according to claim 23 wherein there is a signal recognizable by a user informing the user that the device is operating.

26. The method according to claim 25 wherein the signal is a tone audible to the user.
